(19) United States
(12) Patent Application Publication
(10) Pub. No.: US 2025/0006197 A1
(43) Pub. Date: Jan. 2, 2025

(54) ESTIMATION METHOD, TRAINING METHOD, ESTIMATION DEVICE, AND ESTIMATION PROGRAM

(71) Applicant: NIPPON TELEGRAPH AND TELEPHONE CORPORATION, Tokyo (JP)

(72) Inventors: Yoko TOKUNAGA, Tokyo (JP); Iwaki TOSHIMA, Tokyo (JP); Shiro OZAWA, Tokyo (JP)

(73) Assignee: NIPPON TELEGRAPH AND TELEPHONE CORPORATION, Tokyo (JP)

(21) Appl. No.: 18/707,649

(22) PCT Filed: Dec. 2, 2021
(86) PCT No.: PCT/JP2021/044345

§ 371 Date: May 6, 2024

(51) Int. Cl. G10L 15/32; G10L 15/06; G10L 15/22

(52) U.S. Cl. CPC G10L 15/32; G10L 15/063; G10L 15/22; G10L 2015/0638

(57) ABSTRACT

An estimation device includes an activity score calculation unit that calculates, on the basis of a linguistic feature amount of an utterance in a dialogue transcript of a plurality of persons, an activity score indicating the degree the excitement of a dialogue gives to satisfaction of each participant; an activeness score calculation unit that divides the dialogue transcript by a time axis, and calculates, on the basis of the number of utterances and the number of utterance words of each participant in each zone, an activeness score indicating the degree the activeness of a speech in a dialogue by the participant gives to satisfaction of each participant. Further, there is an influence score calculation unit that divides the dialogue transcript, and calculates an influence score, and a dialogue evaluation estimation unit that estimates a dialogue evaluation score.

### TECHNICAL FIELD

The present invention relates to an estimation method, a learning method, an estimation device, and an estimation program.

### BACKGROUND ART

As an evaluation technique in a group dialogue, there is a technique of estimating the leadership or the contribution from the number of utterances during the dialogue, the frequency of words included in the uttered sentences, the number of nods analyzed from a camera video, and the like. In addition, there is a technique of estimating performance of the entire group by calculating a feature amount by graphically expressing an utterance turn of the dialogue.

### CITATION LIST

### Patent Literature

Patent Literature 1: JP 2012-242528 A

### Non Patent Literature

Non Patent Literature 1: Indrani Bhattacharya et al, “A Multimodal-Sensor-Enabled Room for Unobtrusive Group Meeting Analysis”, ICMI '18, Oct. 16-20, 2018.
Non Patent Literature 2: Uliyana Kubasova et al, “Group Performance Prediction with Limited Context”, ICMI '20 Companion, Oct. 25-29, 2020.

### SUMMARY OF INVENTION

### Technical Problem

When the dialogue is evaluated, the result obtained by the dialogue is evaluated to evaluate the performance of the group itself that has performed the dialogue in many cases. On the other hand, the satisfaction with the dialogue may vary depending on individual participant even if the participant belongs to the same group.

For example, there is a case (first case) where the satisfaction of a person who has been able to contribute to the consensus building of the group by active speech is increased. In addition, there is a case (second case) where the satisfaction of a person who has been able to provide a topic that serves as a trigger for promoting the consensus building of the group is increased.

As for the active speech in the first case, it is necessary to consider an utterance regarding an idea for consensus building or regarding a related topic among utterances. In the second case, the consensus building is promoted by two types of participants: a “first utterer” who first proposes a new idea and topic and a “repeating utterer” who empathizes with the idea and topic proposed by someone and picks up a topic. As described above, a participant who frequently makes utterances that promote consensus building can be said to have “a high influence”, and it is necessary to consider a participant having a high influence and its degree in estimation of evaluation.

However, even if the dialogue can be excited by the speech, the activeness and the influence described above may not be directly linked to the quality of the result, and cannot be evaluated only with the result of the consensus building by the dialogue. In addition, since the satisfaction is different between a person with activeness and a person without activeness, and between a person with a high influence and a person with a low influence, it is considered that each participant has different evaluation with respect to the same dialogue. Then, in the evaluation performed on the group itself, the evaluation of the individual participants could not be expressed.

For example, Patent Literature 1 describes a method of evaluating a dialogue on the basis of information of predetermined speech of the dialogue and the length of the dialogue. However, in the method described in Patent Literature 1, the activeness or the feature amount in which the two types of idea and topic utterers are distinguished is not used, and the evaluation of individual participants in consideration of the activeness and the influence could not be obtained.

In addition, Non Patent Literature 1 describes a method of extracting opinions in the speech from uttered sentences and camera videos and scoring the leadership and the contribution. Non Patent Literature 2 describes a method of creating a graph in which a linguistic feature amount in dialogue, an utterance, utterer, and a topic are set as nodes, and estimating performance of a group using a feature amount obtained from the centrality. Then, in the methods described in Non Patent Literatures 1 and 2, the switching of the utterer and the number of topic utterances are used as a non-linguistic feature and a linguistic feature for estimating the evaluation of the consensus building.

However, in the methods described in Non Patent Literatures 1 and 2, although the switching of the speakers of each utterance is taken into consideration, the “first utterer” and the “repeating utterer” are not distinguished, and thus it cannot be said that the evaluation of individual participants in consideration of the activeness and the influence is appropriately obtained. Then, in the method described in Non Patent Literature 2, as the evaluation of the dialogue, the performance of the entire group is evaluated for the quality of the result of consensus building, and the evaluation of individual participants is not obtained.

The present invention has been made in view of the above, and an object is to provide an estimation method, a learning method, an estimation device, and an estimation program capable of estimating evaluation of a dialogue by each participant of individual participants of a group dialogue.

### Solution to Problem

In order to solve the above-described problem and achieve the object, an estimation method according to the present invention includes: a first calculation process of receiving, as dialogue data of a plurality of persons, at least an input of a dialogue transcript, and calculating, on the basis of a linguistic feature amount of an utterance in the dialogue transcript, an activity score indicating a degree excitement of a dialogue gives to satisfaction of each participant; a second calculation process of dividing the dialogue transcript by a time axis, and calculating, on the basis of a number of utterances and a number of utterance words of each participant in each zone, an activeness score indicating a degree activeness of a speech in a dialogue by the participant gives to satisfaction of each participant; a third calculation process of dividing the dialogue transcript, specifying a first utterer and a repeating utterer for each divided period, and calculating an influence score indicating a degree an influence given to a process and result of consensus building by utterances of the first utterer and the repeating utterer gives to satisfaction of each participant; and a process of estimating a dialogue evaluation score indicating evaluation of the dialogue by each participant on a basis of the activity score, the activeness score, and the influence score.

In addition, a learning method according to the present invention includes: a fourth calculation process of receiving, as training dialogue data of a plurality of persons, at least an input of a dialogue transcript, and calculating, on the basis of a linguistic feature amount of an utterance in the dialogue transcript, an activity score indicating a degree excitement of a dialogue gives to satisfaction of each participant; a fifth calculation process of dividing the dialogue transcript by a time axis, and calculating, on the basis of a number of utterances and a number of utterance words of each participant in each zone, an activeness score indicating a degree activeness of a speech in a dialogue by the participant gives to satisfaction of each participant; a sixth calculation process of dividing the dialogue transcript, specifying a first utterer and a repeating utterer for each divided period, and calculating an influence score indicating a degree an influence given to a process and result of consensus building by utterances of the first utterer and the repeating utterer gives to satisfaction of each participant; and a creation process of creating a model for estimating a dialogue evaluation score indicating an evaluation of a dialogue by each participant by machine learning in which the activity score, the activeness score, and the influence score are used as inputs and satisfaction by subjective evaluation of a participant with respect to the training dialogue data is used as correct answer data.

### Advantageous Effects of Invention

According to the present invention, it is possible to estimate the evaluation of a dialogue by each participant of individual participants of a group dialogue.

### BRIEF DESCRIPTION OF DRAWINGS

FIG. 1 is a diagram schematically illustrating an example of a configuration of an estimation device according to an embodiment.

FIG. 2 is a diagram describing a feature amount used for calculation of an activeness score.

FIG. 3 is a diagram describing an example of a dialogue turn.

FIG. 4 is a diagram describing another example of a dialogue turn.

FIG. 5 is a flowchart illustrating a processing procedure of estimation processing according to an embodiment.

FIG. 6 is a flowchart illustrating an example of a processing procedure of activeness score calculation processing illustrated in FIG. 5.

FIG. 7 is a flowchart illustrating an example of a processing procedure of influence score calculation processing illustrated in FIG. 5.

FIG. 8 is a diagram schematically illustrating an example of a configuration of a learning device according to an embodiment.

FIG. 9 is a flowchart illustrating a processing procedure of learning processing of an embodiment.

FIG. 10 is a diagram illustrating an example of a computer in which a program is executed and thus the estimation device and the learning device are implemented.

### DESCRIPTION OF EMBODIMENTS

Hereinafter, an embodiment of the present invention will be described in detail with reference to the drawings. Note that the present invention is not limited by this embodiment. In addition, in the description of the drawings, the same portions are denoted by the same reference signs.

### EMBODIMENT

The estimation method according to the present embodiment estimates the evaluation of the dialogue by each participant of the group dialogue by using the dialogue data in which the information regarding the dialogue by a plurality of persons is recorded. In the estimation method according to the embodiment, the group dialogue is quantified in terms of three aspects: the activity, the activeness, and the influence of the participant, and the evaluation of the dialogue by each participant is estimated. Accordingly, in the present embodiment, a score obtained by quantifying the evaluation reflecting the satisfaction (or achievement) with the dialogue by individual two or more participants of the group dialogue is estimated.

That is, the estimation method according to the embodiment estimates a dialogue evaluation score that is an evaluation score of the dialogue by each participant on the basis of an activity score, an activeness score, and an influence score. As will be described below, the dialogue evaluation score is a score indicating the satisfaction and further the achievement of each participant. First, the dialogue data used for evaluation of the dialogue by each participant of the group dialogue will be described.

### [Dialogue Data]

The dialogue data is data in which information regarding an evaluation target dialogue is recorded. The dialogue data is data in which information regarding the dialogue is recorded in time series.

The dialogue data includes at least text data (dialogue transcript) in which the content uttered by each participant is transcribed. The dialogue data may include, for example, voice data collected by a microphone.

The dialogue data may include video data obtained by capturing a motion of each participant, vital data obtained by recording the heartbeat or the like of each participant using equipment such as a smartwatch, or the like.

The dialogue data may include individuality data indicating the individuality of each participant participating in the dialogue. The individuality data is data indicating the personality and the sense of value of a participant constituting a dialogue group.

For example, the individuality data may include data of individuality predicted from a result of conducting a questionnaire about personality and past data using an existing technique, and data regarding attributes such as age, work history, and position.

The individuality data is, for example, data based on a result of a questionnaire regarding personality and attributes. Specifically, the individuality data is data based on a result of selecting an option suitable for the participant itself from options such as “agree”, “agree a little”, “disagree a little”, and “disagree” with respect to the question “Do you like talking about yourself in front of people?”. In addition, the individuality data is data based on a result of selecting an option that matches the participant's own personality and sense of value from words such as “silent”, “talkative”, and “extroverted”. Alternatively, the individuality data is data based on a result obtained by the participant performing, for example, 9-grade evaluation on each item.

The individuality data may be based on data of evaluation of each participant by another person. The individuality data may be based on a score of a result of predicting the individuality using past dialogue data or the like.

In the case of using the results of the questionnaire regarding personality and attributes, when the answers of the questionnaire are answers in graded numerical values, the numerical value may be used as it is as the individuality data, or the aggregated value may be used as the individuality data. When the answer to the questionnaire is Yes or No, quantified data in which 1 is Yes and 0 is No can be used as the individuality data.

In the case of giving an answer by selecting an item from non-continuous items such as occupations and preferences, the feature amount of the number of items may be prepared, and data converted into a vector in which the selected item is 1 and the other items are 0 may be used as the individuality data. In the case of free writing, data in which included words are directly used as feature amounts may be used as the individuality data. In addition, in the case of free writing, the written content may be classified into categories, the feature amount of the number of categories may be prepared, and data converted into a vector in which the selected item is 1 and the other items are 0 may be used as the individuality data. The individuality data may be a mixture of questions with different answer methods, such as a question answered by Yes or No, a question answered, for example, on a 7-grade scale, a question with free writing, and the like.

### [Activity Score]

Next, the activity score will be described. The activity score is a numerical value indicating the degree the excitement of the dialogue gives to the satisfaction of each participant. The activity score may be a score numerically indicating how much the dialogue is excited or the elation of the participant's feeling. In particular, in the dialogue of the participants who are strangers to each other, it is assumed that in many cases, emphasis is placed on not the frequency or quality of their own speeches, but on continuity of utterances or excitement of the place as a whole. Based on this assumption, in the present embodiment, the activity score is defined as a numerical value indicating the degree the excitement of the dialogue and the elation of the participants give to the satisfaction.

The activity score of the dialogue is obtained from the dialogue data. For example, in a case where the dialogue data is text data, the linguistic feature amount of the utterance in the dialogue data such as the number of utterances of each participant, the number of utterance words, and the like is used as the activity score. In a case where the dialogue data is voice data, the loudness, the change, and the like of the voice of each participant are used as the activity score. In a case where the dialogue data is video data, the magnitude of gesture, the magnitude of nod, and the like are used as the activity score. When the dialogue data is vital data, the speed, the change, and the like of the heartbeat are used as the activity score.

In addition, in a case where the individuality data is included as the dialogue data, the individuality data may be converted into a numerical value obtained by estimating excitement and elation for each dialogue participant, and may be used as the activity score. For example, a score obtained by scoring the excitement for an outgoing person or the excitement for an introverted person by applying a weight using the individuality data is used as the activity score. In addition, data obtained by quantifying the individuality indicating the personality and the sense of value that can be determined from the individuality data and data obtained by quantifying the activity score that can be determined from the dialogue data other than the individuality data may be combined and used as the feature amount.

### [Activeness Score]

Next, the activeness score will be described. The activeness score is a numerical value indicating the degree the activeness of the speech in the dialogue by the participant gives to the satisfaction of each participant. The activeness score is a numerical value indicating the degree whether or not the participant has been able to give an active speech in the dialogue gives to the satisfaction of each participant. Here, the active speech includes not only a speech that leads the dialogue but also a question that is seen in urging the speaker to talk or delving deeply into the speaker's talk, and a speech regarding empathy. Accordingly, it is determined that the activeness is higher in the case of a substantial speech rather than a mere back channel (back-channeling), and the activeness score increases.

The activeness score of each participant is obtained from the dialogue data. The activeness score is based on the number of utterances and the number of utterance words when each participant's own utterance is focused on. Here, in the present embodiment, the importance of an utterance regarding an idea of consensus building, a related topic, or the like is set to be higher than the importance of other utterances, rather than treating every utterance equally.

For this reason, when the activeness score is obtained, the weight of the back channel or the utterance not related to the consensus building is lowered, and the weight of the dialogue in which the content related to the consensus building is included in the utterance is increased. The utterance not related to the consensus building is, for example, an utterance related to repetition when a character is written on paper or a whiteboard, or communication such as confirmation of spelling and Kanji characters.

### [Influence Score]

Next, the influence score will be described. The influence score is a numerical value indicating the degree the influence given to another participant and the process and result of the consensus building gives to the satisfaction of each participant as to whether the participant has been able to bring excitement to the dialogue by the participant's own speech or give a speech that leads to results. The influence score is a numerical value indicating the degree the influence given to the process and result of the consensus building by the utterances of the first utterer and the repeating utterer described below gives to the satisfaction of each participant. The influence score of each participant is obtained on the basis of the dialogue data and the dialogue turn.

Here, in the process of consensus building, various topics and ideas may appear, and the dialogue may continue regarding such various topics and ideas, or the focus of the dialogue may immediately shift to another topic or idea.

In the present embodiment, a zone of a dialogue talking about a specific topic or idea is defined as a dialogue turn. In actual dialogue, a plurality of topics may be talked about. Moreover, in actual dialogue, a dialogue turn of a more detailed topic may be included in a wide topic dialogue turn.

For this reason, in a case where the dialogue is determined in time series, there is a method of dividing the dialogue such that the dialogue turns for a plurality of different topics and ideas overlap each other, or dividing the dialogue such that a specific dialogue turn is always uniquely determined.

In the present embodiment, the dialogue turn is automatically extracted by determining the utterance content. In the present embodiment, for example, a dialogue turn is extracted from a dialogue transcript using an important word that is a word indicating an idea and a topic. It is sufficient if the important word is a word included in a memo or writing on board regarding an idea and a topic in the process of consensus building, materials such as a proposal as a result of consensus building, or a transcript of oral presentation of a result report, and the extraction method is not limited.

For example, among words included in a proposal of the consensus result, only nouns are regarded as important words. Alternatively, among the words included in the proposal of the consensus result, term frequency-inverse document frequency (TFIDF) of the word is calculated using the proposal of another group, and a word whose calculated value is high is set as an important word. Note that the dialogue turn may be extracted by manual annotation.

The influence score is obtained for each dialogue turn. In each dialogue turn, a dialogue about an idea or a related topic is performed. Here, the consensus building is promoted by two types of participants: the “first utterer” and the “repeating utterer” of the idea and the topic. For this reason, it is necessary to specify the first utterer and the repeating utterer for each dialogue turn.

In the present embodiment, the important word used in the dialogue turn is used to specify the first utterer and the repeating utterer. In the entire dialogue, a person who first utters the important word is referred to as the “first utterer” and a person who utters the important word for the second and subsequent times is referred to as the “repeating utterer”. The first utterer and the repeating utterer may be the same person.

Next, how much the dialogue has been excited with the first utterance and the repeating utterance as a trigger is used as the influence score. The influence score is added to the first utterer and the repeating utterer of the important word on the basis of how long the dialogue about the important word has continued or how much the dialogue frequency has increased due to the utterance of the important word as compared with that before the utterance. However, it is added only to the first utterer in the case of the first utterance of the important word.

### [Dialogue Evaluation Score]

Next, the dialogue evaluation score will be described. The dialogue evaluation score is calculated by combining the activity score, the activeness score, and the influence score obtained on the basis of the dialogue data. The dialogue evaluation score is a score indicating the achievement and the satisfaction of the participant in the dialogue, and is given to each participant. Note that it is also possible to indicate the score of the entire group by taking an average of the scores of the participants.

In the present embodiment, for example, a dialogue evaluation score is acquired using a model. The model uses the activity score, the activeness score, and the influence score each calculated for the dialogue data, which is an estimation target, as inputs, and performs various calculation processing such as weighting of each score to acquire and output the dialogue evaluation score.

The model is trained to estimate the dialogue evaluation score by machine learning in which the activity score, the activeness score, and the influence score each calculated for training dialogue data are used as inputs and the satisfaction by the subjective evaluation of the participant with respect to the training dialogue data is used as correct answer data. In the embodiment, a dialogue evaluation score is similarly calculated with respect to new dialogue data using the trained model, and the consensus evaluation of each participant is estimated.

### [Estimation Device]

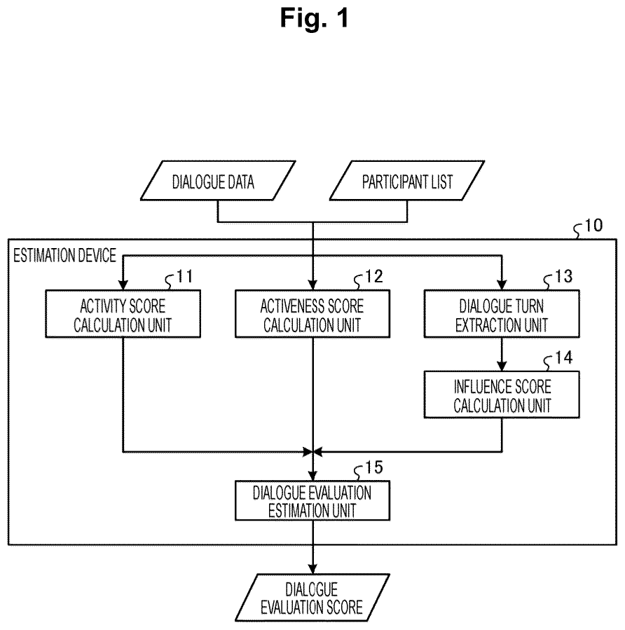

Specifically, an estimation device according to the embodiment will be described. Here, an estimation device that estimates the dialogue evaluation score of each participant for new dialogue data and estimates the evaluation on the dialogue by individual participants of the group dialogue using a model trained using a plurality of pieces of dialogue data and the dialogue evaluation score as correct answer data will be described. FIG. 1 is a diagram schematically illustrating an example of a configuration of the estimation device according to the embodiment.

An estimation device 10 illustrated in FIG. 1 is implemented by, for example, a predetermined program being read by a computer or the like including read only memory (ROM), random access memory (RAM), a central processing unit (CPU), and the like, and the CPU executing the predetermined program. In addition, the estimation device 10 includes a communication interface that transmits and receives various types of information to and from another device connected via a network or the like. As illustrated in FIG. 1, the estimation device 10 includes an activity score calculation unit 11 (first calculation unit), an activeness score calculation unit 12 (second calculation unit), a dialogue turn extraction unit 13, an influence score calculation unit 14 (third calculation unit), and a dialogue evaluation estimation unit 15 (estimation unit).

The estimation device 10 receives new dialogue data and a participant list as inputs. The participant list is a list of k dialogue participants as h₁, . . . , hₖ, respectively. The dialogue data includes at least a transcript of the content uttered by each participant.

Note that the estimation device 10 may use, as the dialogue data, data with which it is possible to determine the dialogue state, such as an uttered voice, a moving image, and biometric sensor information. In addition, the estimation device 10 may use, as the dialogue data, individuality data indicating individuality such as a questionnaire result asking about attributes such as age, work history, and position, sense of value, experiences, preferences, and the like. The estimation device 10 may include any number of types of dialogue data as long as the dialogue data is the above-described dialogue data.

Then, the estimation device 10 estimates dialogue evaluation scores F₁, . . . , Fₖ of the respective participants. The dialogue evaluation score is a score indicating the satisfaction of each participant with respect to the dialogue, and is a score obtained by evaluating whether or not each participant is satisfied with the dialogue.

### [Activity Score Calculation Unit]

The activity score calculation unit 11 uses the dialogue transcript, which is the dialogue data, and the participant list as inputs, and calculates and outputs the activity score for each participant of the dialogue on the basis of the linguistic feature amount of the utterance in the dialogue data. Here, total utterance time UT=(u₁, . . . , uₗ), the number of back channels BC=(b₁, . . . , bₖ) of each participant, the number of utterances W=(w₁, . . . , wₖ) of proper nouns of each participant, and personality and attributes score PNT=(p₁, . . . , pₖ) of each participant h₁, . . . , hₖ are extracted as feature amounts.

Here, the back channel can be extracted from the dialogue data on the basis of a definition such as an utterance that does not include a verb, a noun, an adjective, a numeral, or the like. The number of proper noun utterances is the number of counts obtained by performing morphological analysis on a transcript of an utterance in advance and counting only proper nouns from words. The personality and attributes score is obtained by aggregating the results of a questionnaire and quantifying them using a classification method such as Big Five personality traits or an existing scale.

It is sufficient if the feature amount used for the activity score is a numerical value indicating the state of the entire dialogue. Accordingly, the estimation device 10 may use, as the feature amount used for the activity score, other linguistic feature amounts, vital data such as a motion, an expression, and a heartbeat acquired from a video or a sensor, and/or non-linguistic feature amounts based on individuality data.

Each feature amount of each participant may be a scalar value or a vector value. For example, the estimation device 10 may use, as the feature amount, the number of appearances of each of c proper nouns as the number of proper noun utterances Wⱼ=(w′ⱼ₁, . . . , w′_{jc}). The estimation device 10 may use, as the feature amount, d types of personality trait factors and attributes as the personality and attributes score pⱼ=(p′ⱼ₁, . . . , p′_{jc}).

In addition, the estimation device 10 may extract and use only the feature amount of the participant himself/herself corresponding to the dialogue evaluation. The estimation device 10 may use a value obtained by performing aggregation such as an average, a maximum value, a minimum value, or a variance of all the persons. The estimation device 10 may use, as the feature amount, a numerical value that can be extracted or calculated from the dialogue data, such as the average volume and the maximum volume of the microphone, the number of times of motions such as nodding, the maximum heart rate, and the number of times of exceeding the average heart rate. The estimation device 10 may classify attributes such as age and position from data indicating individuality and use a number expressing a group to which the participant belongs.

As an example, the estimation device 10 calculates the activity score using four types of individually calculated feature amounts: the total utterance time, the number of back channels, the number of utterances of proper nouns, and the personality and attributes score for all the persons participated in the dialogue. In this case, activity score A can be indicated by Formula (1) using the feature amounts (UT, BC, W, PNT).

$$[ Math . 1 ]$$

$$A = ( \begin{matrix}UT \\ BC \\ W \\ PNT\end{matrix} ) = ( \begin{matrix}{u}_{1} \\ ⋮ \\ {u}_{k} \\ {b}_{1} \\ ⋮ \\ {b}_{k} \\ {w}_{1} \\ ⋮ \\ {w}_{k} \\ {p}_{1} \\ ⋮ \\ {p}_{k}\end{matrix} ) \qquad ( 1 )$$

### [Activeness Score Calculation Unit]

The activeness score calculation unit 12 calculates and outputs an activeness score for each participant of the dialogue on the basis of the dialogue data and the participant list. Here, the activeness score calculation unit 12 divides the dialogue data into utterances of each participant, and focuses only on the utterance of the target participant for which the activeness score is calculated.

The utterance includes a “substantial utterance” that promotes consensus building or provides and activates a topic of dialogue, and an “empathy utterance” expressing listening to the dialogue of another participant like back-channeling.

The activeness score is a score the numerical value of which increases for a participant who makes more utterances and whose utterances are substantial utterances. Then, the activeness score is a score the numerical value of which decreases for a participant who makes fewer speeches and makes more empathy utterances than substantial utterances. Accordingly, in a case where a person expresses many opinions or in a case where a topic related to the theme of the dialogue is talked about, it becomes a factor that the activeness score becomes high. In addition, even in a case where a person is listening to the speech of another person, in a case where a person asks a question in order to expand on the topic or a person summarizes or organizes the main point of the speech, the person actively participates in the dialogue, which becomes a factor that the activeness score becomes high.

For example, an example in which scoring is performed using the number of utterances and a part of speech of a word included in the utterance will be described as the processing of the activeness score calculation unit 12. Note that the method of calculating the activeness score is not limited thereto, and it is sufficient if the score indicates the feature of the activeness score described above.

The activeness score calculation unit 12 divides the transcript of the dialogue, which is an estimation target, by the time axis, and calculates the activeness score on the basis of the number of utterances and the number of utterance words of each participant in each zone. Specifically, the activeness score calculation unit 12 divides the dialogue every m minutes for a participant hᵢ for which the activeness score is calculated. The activeness score calculation unit 12 morphologically analyzes the transcript of the dialogue uttered by the participant hᵢ in each zone and divides it into words.

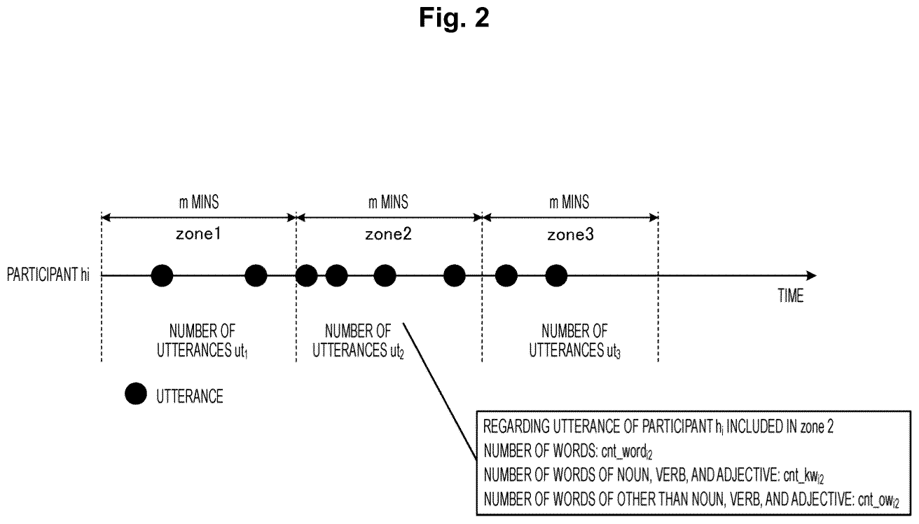

FIG. 2 is a diagram describing a feature amount used for calculation of an activeness score. As illustrated in FIG. 2, the number of words of the utterance in a certain zone z of the participant hᵢ is cnt_word_{iz}, where the number of words corresponding to a noun, a verb, or an adjective is cnt_kw_{iz}, and the number of words of other than the noun, the verb, or the adjective is cnt_ow_{iz}. For each zone, zone activeness score Ps′_{iz} of the participant hᵢ can be indicated as Formula (2). α, β, and γ in Formula (2) indicate weights of the respective numbers of words.

$$[ Math . 2 ]$$

$${Ps}_{iz}^{′} = α {cnt\_word}_{izn} + β {cnt\_kw}_{izn} - γ {cnt\_ow}_{izn} \qquad ( 2 )$$

Note that the method of calculating the zone activeness score is not limited thereto, and it is sufficient if the score is such that the substantial utterance works in a positive direction and the empathy utterance works in a negative direction. Accordingly, the activeness score may be calculated not only on the basis of the number of words but also on the basis of the number of utterances, or may be calculated on the basis of a motion or behavior with which it is possible to distinguish between the substantial utterance and the empathy utterance.

In addition, the activeness score may be a relative value with respect to another participant. Specifically, for a certain zone, the activeness score calculation unit 12 may use, as the activeness score, a value obtained by dividing the zone activeness score of the target participant by the sum of the zone activeness scores of all the participants.

The activeness score calculation unit 12 calculates the zone activeness score in all the zones, and uses the average, variance, maximum value, minimum value, and the like of all the zones of the zone activeness score as activeness score Psi. For example, the activeness score Psi can be expressed by a vector indicated in Formula (3).

$$[ Math . 3 ]$$

$${Ps}_{i} = ( mean ( {Ps}_{iz}^{′} ) , var ( {Ps}_{iz}^{′} ) , max ( {Ps}_{iz}^{′} ) , min ( {Ps}_{iz}^{′} ) ) \qquad ( 3 )$$

It is sufficient if the activeness score is a value calculated on the basis of the zone activeness score, and it is given to each participant. In addition, the activeness score may be a scalar value or a vector value.

### [Dialogue Turn Extraction Unit]

The dialogue turn extraction unit 13 divides the dialogue data into dialogue turns on the basis of the dialogue data and the participant list, and outputs a start point and an end point of each dialogue turn and an important word at that time.

It is sufficient if the start point and the end point of the dialogue turn represent where the start and the end of the dialogue turn correspond in the dialogue data. The start point and the end point of the dialogue turn may be, for example, an elapsed time from the start of the dialogue, or may be information that uniquely identifies utterances corresponding to the start and the end. In addition, the dialogue turn extraction unit 13 may divide the dialogue data into time zones at a specific time such as every five minutes or every one minute, and output information that can uniquely specify a time zone including the start and end utterances.

The dialogue turn extraction unit 13 extracts the dialogue turn using an important word list. As an example, a case where each dialogue group uses an important word list based on a report summarizing a result of consensus building will be described.

In the report, ideas and the like that are a consensus of each group are described. In the embodiment, morphological analysis is performed on the sentence written in the report, and only nouns are extracted from the divided words. At this time, in the embodiment, other parts of speech such as verbs and adjectives may also be extracted.

Here, the extracted word group includes a word expressing an idea and a word that is generally frequently used or a word that is used in any group such as a topic of a dialogue of consensus building.

For example, in the case of consensus building of considering a travel plan, words such as “travel”, “move”, and “meal” are common, and are not words that characteristically indicate the idea of the group. For this reason, it is necessary to remove such words. The removal method is not limited, and sorting may be performed manually.

In addition, it is also possible to use a report of another group, obtain TFIDF or inverse document frequency (IDF) by regarding each report as one document, and sort specific words in the group. Document frequency (DF) is the number of documents in which the word appears, and in TFIDF or IDF, a reciprocal is a score. For this reason, the score tends to decrease as the word appears in the reports of many groups, and the score tends to increase as the word appears only in the group. By using TFIDF or IDF or a score having a tendency similar to that of TFIDF and IDF, it is possible to specify a word indicating an idea of a target dialogue group.

In a case where the dialogue is not performed in a plurality of groups, a similar effect can be obtained by using another type of dialogue data or using various general document groups such as general news articles, blog articles, and Social Networking Service (SNS) articles.

The dialogue turn extraction unit 13 uses the word group thus obtained as the important word list in the dialogue group. The important word list may include synonyms, similar words, related words, and the like of the word using external data and the like. In addition, the same important word list may be commonly used by a plurality of dialogue groups. Hereinafter, it is assumed that the important word list is IW=(iw₁, . . . , iwᵤ, . . . , iwᵢ).

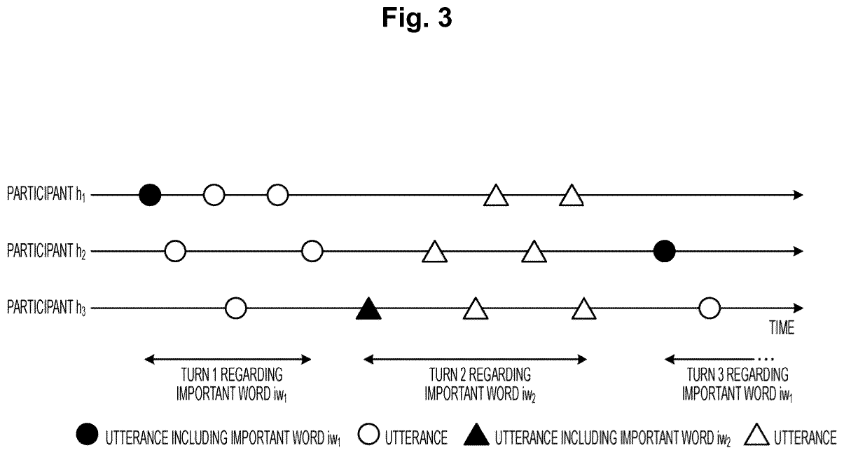

Then, the dialogue turn extraction unit 13 follows the dialogue transcript in time series, and extracts, as a dialogue turn, an uttered sentence in which a word (important word) included in the important word list appears from the dialogue transcript. FIG. 3 is a diagram describing an example of a dialogue turn.

In the case of FIG. 3, h₁ makes an utterance including the important word iw₁. At this time point, since there is no other participant who has uttered the important word iw₁, the dialogue turn extraction unit 13 determines the participant hᵢ as the “first utterer”. The dialogue turn extraction unit 13 regards that the utterances of all the participants after the utterance follow the dialogue regarding the important word iw₁ uttered by the participant h₁.

After a while of dialogue, the participant h₃ made an utterance including the important word iw₂. In a case where the important word iw₁ is not included in the subsequent utterances of all the participants, it is considered that the dialogue related to iw₁ ends here and the dialogue topic has moved to iw₂. Therefore, the dialogue turn extraction unit 13 regards an utterance including the important word iw₁ by the first participant h₁ indicated by the black circle to an utterance immediately before the utterance including the important word iw₂ of the participant h₃ as a dialogue turn related to the important word iw₁. Here, this is Turn 1.

Similarly, the dialogue turn extraction unit 13 also obtains the dialogue turn for the important word iw₂ uttered by the participant h₃, and this is Turn 2. Next to Turn 2, a dialogue turn regarding the important word iw₁ similar to Turn 1 starts. The dialogue turn extraction unit 13 sets the participant h₂ who first utters the important word iw₁ in this dialogue turn as the “repeating utterer”. In Turn 3, a dialogue turn is similarly obtained.

In this way, the topic to be the focus of the dialogue may be changed from one topic to the next, but there may be a case where another topic is brought up in the middle and the topic is gradually changed, or a topic not related to consensus building may be brought up. Therefore, the dialogue turn extraction unit 13 eliminates these influences by providing the upper limit on the number of dialogues or the upper limit on the dialogue time.

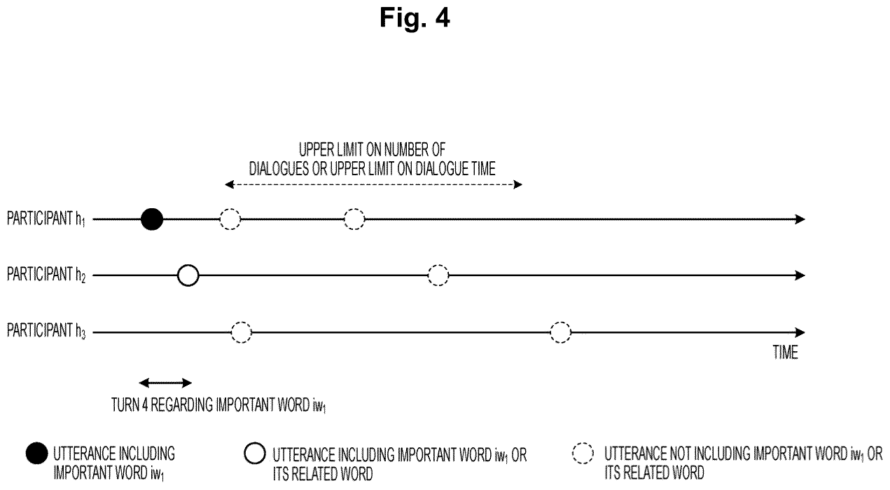

FIG. 4 is a diagram describing another example of a dialogue turn. FIG. 4 illustrates an example in which the participant hᵢ utters the important word iw₁, but thereafter, a topic that does not include any word in an important word group or is not related to consensus building is brought up.

In this case, when the dialogue turn of the important word iw₁ is set until the next important word appears, the estimation of the evaluation may be adversely affected. For this reason, in a case where the utterance including an important word or its related word does not appear within the specific number of dialogues or the specific dialogue time, the dialogue turn extraction unit 13 separates the dialogue turn relative to the preceding utterance. Note that the related word is a word deeply associated with the important word, such as a co-occurrence word in the utterance with respect to the important word or a synonym or a similar word that can be extracted using external data.

FIG. 4 illustrates an example in which the upper limit on the number of dialogues is regarded as four. The participant h₁ makes an utterance including the important word iw₁, and then the participant h₂ makes an utterance including a related word of the important word iw₁. Thereafter, the important word or the related word is not included in the four utterances, which is the upper limit on the number of dialogues. Accordingly, the dialogue turn extraction unit 13 extracts an utterance up to the preceding utterance of the participant h₂ as a dialogue turn (Turn 4).

### [Influence Score Calculation Unit]

The influence score calculation unit 14 divides the transcript of the dialogue, which is an estimation target, specifies the first utterer and the repeating utterer for each divided period, and calculates the influence score. The influence score calculation unit 14 calculates and outputs the influence score by using each dialogue turn extracted by the dialogue turn extraction unit 13, and the dialogue data. The influence score calculation unit 14 uses the same important word list as the important word list used by the dialogue turn extraction unit 13.

First, for a certain dialogue turn turnₓ, an important word of the dialogue turn is iwᵤ, the first utterer of the important word iwᵤ is fpᵤ, and a repeating utterer in the dialogue turn is rpᵤ. Here, fpᵤ=rpᵤ, that is, the first utterer and the repeating utterer may be the same person. In addition, in a case where the important word iw₁ appears for the first time in this dialogue turn, there is no repeating utterer.

In this dialogue turn turnₓ, a dialogue is performed using an utterance including the important word iwᵤ by the repeating utterer rpᵤ as a trigger. In the first place, the important word iwᵤ has been proposed by the first utterer fpᵤ. Therefore, the influence score calculation unit 14 scores the influence and gives the score as the feature amount of rpᵤ and fpᵤ.

It is sufficient if the influence score is calculated using the information of the dialogue performed in the corresponding dialogue turn, and details are not limited. For example, the influence score calculation unit 14 calculates the influence score on the basis of the number of utterances and/or the number of utterance words of all the participants included in the dialogue turn turnₓ, the utterance frequency of all the participants in the dialogue turn turnₓ, the number of utterances of an important word iwₓ and its related word and/or the number of utterers included in the dialogue turn turnₓ, and the like.

In addition, the influence score calculation unit 14 may calculate the influence score by using a value compared with a state in a predetermined period before the dialogue turn turnₓ starts, such as a dialogue turn turnₓ₋₁ that is the dialogue turn immediately before the dialogue turn turnₓ or one minute or five minutes immediately before the dialogue turn turnₓ starts. For example, in order to see a change in the number of utterances of all the participants, the influence score calculation unit 14 calculates the influence score by using a value obtained by subtracting the number of utterances in the dialogue turn turnₓ₋₁ from the number of utterances in the dialogue turn turnₓ.

For example, the influence score calculation unit 14 extracts, as feature amounts, time fₓ₁ of the dialogue turn turnₓ, a sum fₓ₂ of the numbers of utterances of all the participants, and the number of utterances fₓ₃ of the important word iwᵤ and its related word included in the dialogue turn turnₓ. Note that the feature amount is not limited thereto, and may be any numerical value that can be calculated for each turn from the dialogue data.

The influence score calculation unit 14 adopts, as the influence score of each participant, a sum, a variance, a maximum value, a minimum value, and the like of feature amounts of turns in which the participant is the first utterer or the repeating utterer. At this time, the influence score calculation unit 14 may change the weight of the feature amount depending on the case of the first utterer and the case of the repeating utterer. For example, it is assumed that the participant hᵢ becomes the first utterer in a dialogue turn turn₁ and becomes a repeating utterer in a dialogue turn turn₃.

In a case where the sum of the feature amounts is used as the influence score, an influence score Fᵢ of the participant hᵢ at this time can be indicated as, for example, Formula (4).

$$[ Math . 4 ]$$

$${F}_{i} = θ ( {f}_{11} + {f}_{12} + {f}_{13} ) + ( 1 - θ ) ( {f}_{31} + {f}_{32} + {f}_{33} ) \qquad ( 4 )$$

At this time, θ is a weight in the case of the first utterer and the case of the repeating utterer, and 0<θ≤1. Note that, in Formula (4), the influence score is expressed by the sum of the feature amounts of the case of the first utterer and the case of the repeating utterer, but as described above, it is not limited thereto.

For example, the influence score calculation unit 14 may set, as the influence score, a feature amount separately between the case of the first utterer and the case of the repeating utterer.

For example, when the feature amount in the turn of the first utterer is (Sum_{f}, Var_{f}, Max_{f}, Min_{f}) and the feature amount in the turn of the repeating utterance is (Sumᵣ, Varᵣ, Maxᵣ, Minᵣ), the influence score Fᵢ can be expressed as a multi-dimensional vector indicated in Formula (5).

$$[ Math . 5 ]$$

$${F}_{i} = ( ( {Sum}_{f} , {Var}_{f} , {Max}_{f} , {Min}_{f} ) , ( {Sum}_{r} , {Var}_{r} , {Max}_{r} , {Min}_{r} ) ) \qquad ( 5 )$$

### [Dialogue Evaluation Estimation Unit]

The dialogue evaluation estimation unit 15 estimates the dialogue evaluation score on the basis of the activity score, the activeness score, and the influence score calculated with respect to the dialogue data, which is an estimation target.

The dialogue evaluation estimation unit 15 inputs the feature amounts of the activity score, the activeness score, and the influence score calculated with respect to the dialogue data, which is an estimation target, to the trained model, and acquires the dialogue evaluation score output from the model. The model is configured by a neural network or the like, and is trained in a learning device 20 to be described below. Note that the dialogue evaluation estimation unit 15 may estimate the dialogue evaluation score using not only the trained model but also a mathematical formula or a threshold.

### [Estimation Processing]

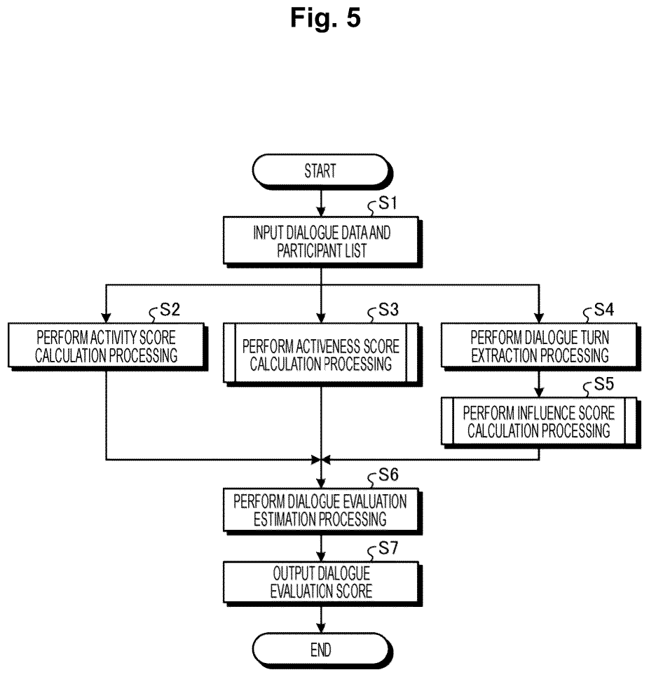

Next, estimation processing executed by the estimation device 10 will be described. FIG. 5 is a flowchart illustrating a processing procedure of estimation processing according to an embodiment.

As illustrated in FIG. 5, when receiving the input of the dialogue data, which is an estimation target for the dialogue evaluation score, and the participant list (step S1), the estimation device 10 outputs the received dialogue data and participant list to the activity score calculation unit 11, the activeness score calculation unit 12, and the dialogue turn extraction unit 13.

The activity score calculation unit 11 performs the activity score calculation processing of calculating and outputting an activity score for each participant of the dialogue on the basis of the dialogue data and the participant list (step S2). The activeness score calculation unit 12 performs the activeness score calculation processing of calculating and outputting an activeness score for each participant of the dialogue using the dialogue data and the participant list as inputs (step S3).

The dialogue turn extraction unit 13 performs dialogue turn extraction processing of dividing the dialogue data into dialogue turns on the basis of the dialogue data and the participant list and outputting a start point and an end point of each dialogue turn and an important word at that time (step S4). The influence score calculation unit 14 performs influence score calculation processing of calculating and outputting the influence score by using each dialogue turn extracted by the dialogue turn extraction unit 13, and the dialogue data (step S5).

The dialogue evaluation estimation unit 15 performs dialogue evaluation estimation processing of estimating a dialogue evaluation score of each participant on the basis of feature amounts of the activity score, the activeness score, and the influence score calculated with respect to the dialogue data, which is an estimation target (step S6). Then, the dialogue evaluation estimation unit 15 outputs the estimated dialogue evaluation score (step S7) and ends the processing.

### [Activeness Score Calculation Processing]

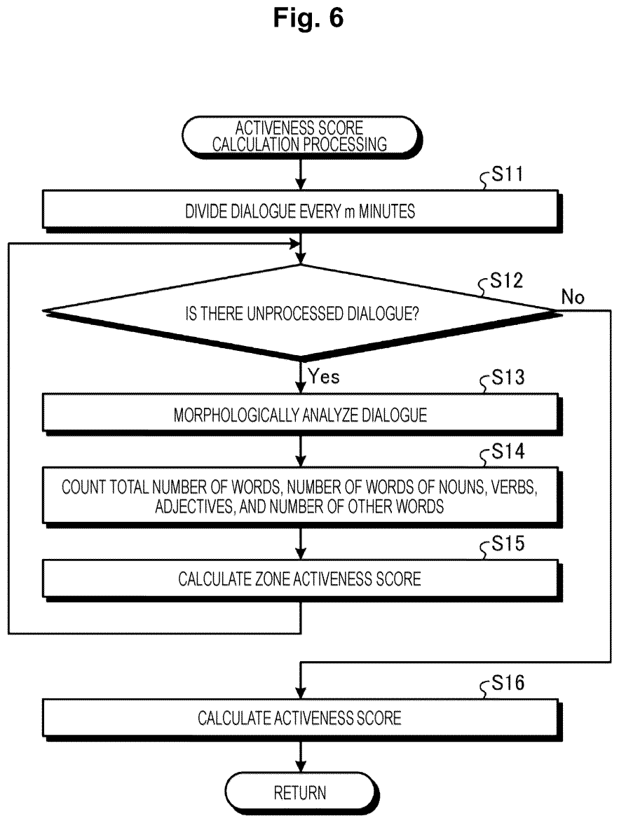

Next, a processing procedure of the activeness score calculation processing (step S3) will be described. FIG. 6 is a flowchart illustrating an example of a processing procedure of activeness score calculation processing illustrated in FIG. 5.

As illustrated in FIG. 6, the activeness score calculation unit 12 divides the dialogue every m minutes for the participant hᵢ, who is a target of calculation of the activeness score (step S11). The activeness score calculation unit 12 determines whether or not there is an unprocessed dialogue among the divided dialogues (step S12).

In a case where there is an unprocessed dialogue among the divided dialogues (step S12: Yes), the activeness score calculation unit 12 morphologically analyzes the dialogue (the transcript of the dialogue uttered by the participant hᵢ in each zone) with respect to the unprocessed dialogue among the divided dialogues (step S13), and divides the dialogue into words. The activeness score calculation unit 12 counts the total number of words, the number of words of nouns, verbs, adjectives, and the number of other words for each of the divided words (step S14).

Regarding this divided dialogue, the activeness score calculation unit 12 applies the total number of words, the number of words of nouns, verbs, and adjectives, and the number of counts of other words to, for example, Formula (2) to calculate the zone activeness score of the participant (step S15). After the processing of step S15, the activeness score calculation unit 12 proceeds to step S12.

In a case where there is no unprocessed dialogue among the divided dialogues (step S12: No), the activeness score calculation unit 12 calculates an activeness score of the participant hᵢ on the basis of each zone activeness score of the participant hᵢ (step S16).

### [Influence Score Calculation Processing]

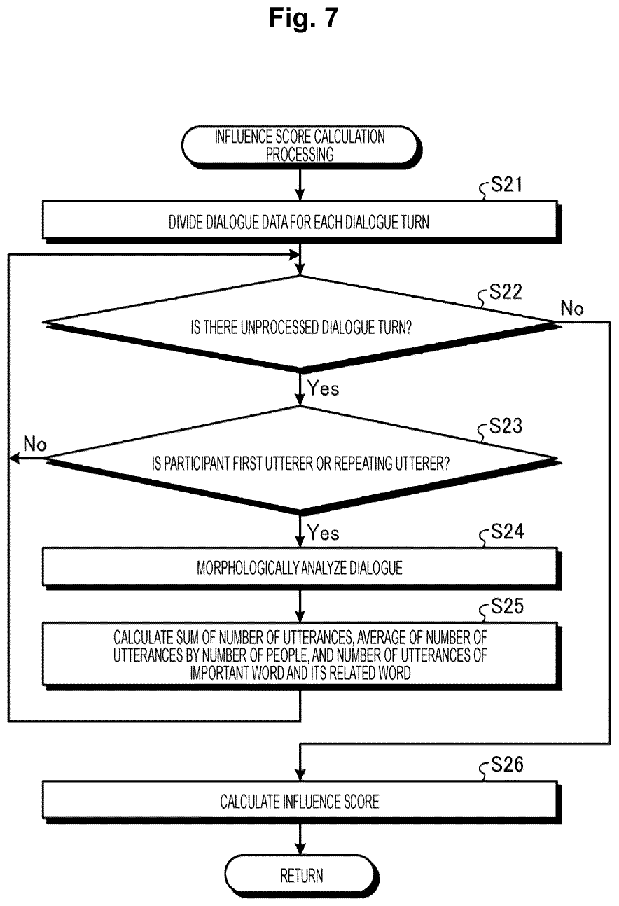

Next, a processing procedure of the influence score calculation processing (step S5) will be described. FIG. 7 is a flowchart illustrating an example of a processing procedure of influence score calculation processing illustrated in FIG. 5.

As illustrated in FIG. 7, the influence score calculation unit 14 divides the dialogue data, which is a target of the calculation of the influence score, for each dialogue turn on the basis of each dialogue turn extracted by the dialogue turn extraction unit 13, and the dialogue data (step S21). The influence score calculation unit 14 determines whether or not there is an unprocessed dialogue turn among the divided dialogue turns (step S22).

When there is an unprocessed dialogue turn among the divided dialogue turns (step S22: Yes), the influence score calculation unit 14 determines whether the participant is the first utterer or the repeating utterer (step S23). When the participant is not the first utterer or the repeating utterer (step S23: No), the influence score calculation unit 14 returns to step S22.

When the participant is the first utterer or the repeating utterer (step S23: Yes), the influence score calculation unit 14 morphologically analyzes the dialogue performed in the dialogue turn to be processed (step S24). The influence score calculation unit 14 calculates the sum of the number of utterances, the average of the number of utterances by the number of people, and the number of utterances of the important word and its related word (step S25). After the processing of step S25, the influence score calculation unit 14 returns to step S22.

In a case where there is no unprocessed dialogue turn among the divided dialogue turns (step S22: No), the influence score calculation unit 14 applies the sum of the number of utterances, the average of the number of utterances by the number of people, and the number of utterances of the important word and its related word to, for example, Formula (4) or (5) to calculate the influence score (step S26).

### [Learning Device]

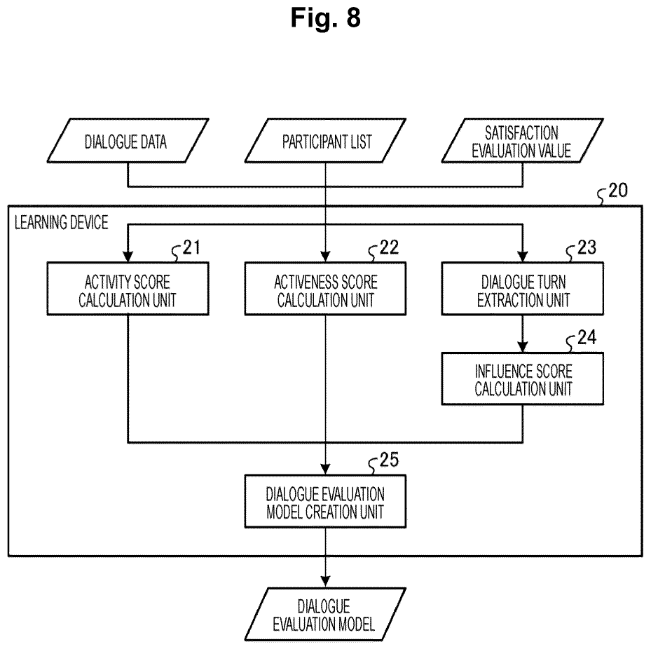

Next, a learning device that trains a model used by the estimation device 10 will be described. FIG. 8 is a diagram schematically illustrating an example of a configuration of a learning device according to an embodiment.

The learning device 20 illustrated in FIG. 8 is implemented by, for example, reading a predetermined program in a computer or the like including ROM, RAM, a CPU, and the like and the CPU executing the predetermined program. In addition, the learning device 20 includes a communication interface that transmits and receives various types of information to and from another device connected via a network or the like. As illustrated in FIG. 8, the learning device 20 includes an activity score calculation unit 21, an activeness score calculation unit 22, a dialogue turn extraction unit 23, an influence score calculation unit 24, and a dialogue evaluation model creation unit 25.

The learning device 20 receives training dialogue data, a participant list, and a satisfaction evaluation value as inputs. The input of the learning device 20 is a set group of training dialogue data, a participant list (h₁, . . . , hₖ), and a satisfaction evaluation value (S₁, . . . . Sₖ).

The dialogue data includes at least a transcript of the content uttered by each participant, and may include individuality data of each participant acquired in a questionnaire survey. The satisfaction evaluation value is, for example, a value obtained by subjectively evaluating whether or not the participant himself/herself is satisfied with the dialogue using a questionnaire using an n-point scale. At this time, a questionnaire may be conducted by providing a plurality of evaluation axes such as the activeness, the influence, the enjoyment of dialogue, the satisfaction with a consensus result, and a value obtained by aggregating the evaluation axes may be used as the satisfaction evaluation value. In addition, a result objectively evaluated by a third party by looking at the dialogue or the dialogue data may be used as the satisfaction evaluation value.

The activity score calculation unit 21 has the same function as the activity score calculation unit 11. The activity score calculation unit 21 calculates and outputs an activity score for each participant of the dialogue on the basis of the input training dialogue data and participant list.

The activeness score calculation unit 22 has the same function as the activeness score calculation unit 12. The activeness score calculation unit 22 calculates and outputs an activeness score for each participant of the dialogue on the basis of the training dialogue data and the participant list.

The dialogue turn extraction unit 23 has the same function as the dialogue turn extraction unit 13. The dialogue turn extraction unit 23 divides the training dialogue data into dialogue turns on the basis of the training dialogue data and the participant list, and outputs a start point and an end point of each dialogue turn and an important word at that time.

The influence score calculation unit 24 has the same function as the influence score calculation unit 14. The influence score calculation unit 24 calculates and outputs the influence score by using each dialogue turn extracted by the dialogue turn extraction unit 23, and the training dialogue data.

The dialogue evaluation model creation unit 25 creates and outputs a model for estimating the dialogue evaluation using the activity score, the activeness score, and the influence score calculated using the training dialogue data. Here, an example of creating a model using machine learning is described. The dialogue evaluation model creation unit 25 creates a model for estimating the dialogue evaluation score by machine learning in which the activity score for each participant calculated by the activity score calculation unit 21, the activeness score calculated by the activeness score calculation unit 22, and the influence score calculated by the influence score calculation unit 24 are used as inputs and the satisfaction by the subjective evaluation of the participant with respect to the training dialogue data is used as correct answer data.

The dialogue evaluation model creation unit 25 trains the model using a method such as random forest, support vector machine (SVM), deep learning, or the like. Note that any machine learning method may be used as the model training method as long as the method weights the feature amount using correct answer data. The dialogue evaluation model creation unit 25 appropriately tunes the parameters of the model using the correct answer data. The model output as a result of the training is used in the dialogue evaluation estimation unit 15 of the estimation device 10.

Note that the dialogue evaluation model creation unit 25 may not necessarily use machine learning for model training. For example, the dialogue evaluation model creation unit 25 may create a model for calculating the dialogue evaluation score by correlating the feature amounts of the various scores with the correct answer data and using only the feature amount having a high correlation or by calculating the weight of the feature amount according to the correlation. For example, the dialogue evaluation model creation unit 25 may create a model for estimating the level of the dialogue evaluation score depending on whether or not a specific feature amount exceeds a threshold or whether or not a weighted sum of feature amounts exceeds a threshold.

The dialogue evaluation model creation unit 25 may set the weights of the feature amounts to the three types of the total feature amount of the activity score, the total feature amount of the activeness score, and the total feature amount of the influence score, or may add a weight to each feature amount of each score. That is, a dialogue evaluation score Sᵢ is expressed by Formula (6).

$$[ Math . 6 ]$$

$${S}_{i} = {ω}_{A} A + {ω}_{P} {Ps}_{i} + {ω}_{F} {F}_{i} \qquad ( 6 )$$

ω_{A}, ωₚ, and ω_{F} take a scalar value when each score is a scalar value, and may be a scalar value or a vector value when each score is a vector value. In addition, for example, in a case where it is known in advance that any of the activity, the activeness, and the influence is particularly emphasized from the personality traits, an interview, and the like of the participant, adjustment such as increasing its weight may be performed here.

In the present embodiment, the example in which the dialogue evaluation score is a scalar value has been described, but the dialogue evaluation score may be a vector value, the dialogue evaluation may be determined by the magnitude of the vector, or an element of each vector may be a factor of the dialogue evaluation such as “consensus”, “activity”, and “influence”.

### [Learning Processing]

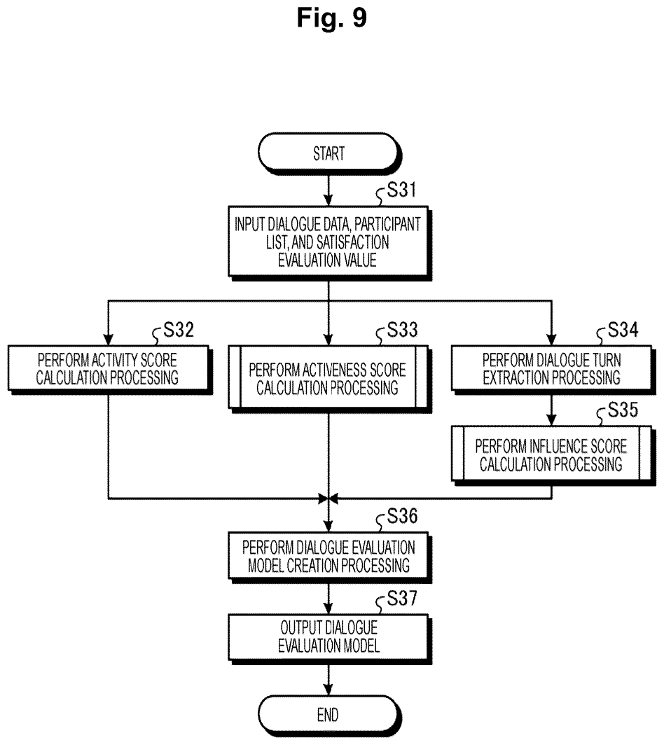

Next, learning processing executed by the learning device 20 will be described. FIG. 9 is a flowchart illustrating a processing procedure of learning processing of an embodiment.

As illustrated in FIG. 9, the learning device 20 receives training dialogue data, a participant list, and a satisfaction evaluation value as inputs (step S31).

Similarly to the processing of step S2 illustrated in FIG. 5, the activity score calculation unit 21 performs the activity score calculation processing of calculating and outputting an activity score for each participant of the dialogue on the basis of the training dialogue data and the participant list (step S32). Similarly to the processing of step S3 illustrated in FIG. 5, the activeness score calculation unit 22 performs the activeness score calculation processing of calculating and outputting an activeness score for each participant of the dialogue using the training dialogue data and the participant list as inputs (step S33).

Similarly to the processing of step S4 illustrated in FIG. 5, the dialogue turn extraction unit 23 performs dialogue turn extraction processing of dividing the dialogue data into dialogue turns on the basis of the training dialogue data and the participant list and outputting a start point and an end point of each dialogue turn and an important word at that time (step S34). Similarly to the processing of step S5 illustrated in FIG. 5, the influence score calculation unit 24 performs influence score calculation processing of calculating and outputting the influence score by using each dialogue turn extracted by the dialogue turn extraction unit 13, and the training dialogue data (step S35).

The dialogue evaluation model creation unit 25 performs dialogue evaluation model creation processing of creating a model for estimating the dialogue evaluation using the activity score, the activeness score, and the influence score calculated using the training dialogue data (step S36). The dialogue evaluation model creation unit 25 outputs the created model to the estimation device 10 (step S37), and ends the processing.

### Effects of Embodiment

As described above, the estimation device 10 according to the embodiment receives, as the dialogue data, at least an input of the transcript of the dialogue, which is an estimation target, and calculates the activity score indicating the degree the excitement of the dialogue gives to the satisfaction of each participant on the basis of the linguistic feature amount of the utterance in the dialogue data. The estimation device 10 divides the transcript of the dialogue, which is an estimation target, by the time axis, and calculates the activeness score indicating the degree the activeness of the speech in the dialogue by the participant gives to the satisfaction of each participant on the basis of the number of utterances and the number of utterance words of each participant in each zone. The estimation device 10 divides the transcript of the dialogue, which is an estimation target, specifies the first utterer and the repeating utterer for each divided period, and calculates the influence score indicating the degree the influence given to the process and result of the consensus building by the utterances of the first utterer and the repeating utterer gives to the satisfaction of each participant. The estimation device 10 estimates the dialogue evaluation score indicating the evaluation of the dialogue by each participant on the basis of the activity score, the activeness score, and the influence score.

The evaluation of the dialogue by a group of the plurality of persons is affected by how the participants actively participate in the dialogue, whether the dialogue is excited by their own speeches, and whether the consensus building is promoted.

The estimation device 10 calculates an activeness score and an influence score related thereto, and further estimates a dialogue evaluation score to be combined with an activity score calculated from the feature amount of the utterance or the behavior in the dialogue data. As a result, the estimation device 10 can appropriately estimate the participant's evaluation of the dialogue by each participant of a group dialogue reflecting the satisfaction with the dialogue of the individual dialogue participant. Further, the estimation device 10 specifies the first utterer and the repeating utterer, and estimates the dialogue evaluation score appropriately reflecting the influence given to the process and result of consensus building by the utterances of the first utterer and the repeating utterer.

In addition, the estimation device 10 calculates the activity score using the non-linguistic feature amount based on the vital data of each participant and/or the individuality data indicating the individuality of each participant, and can estimate the dialogue evaluation score more reflecting the state of the entire dialogue.

In addition, the estimation device 10 can extract the uttered sentence in which the important word has appeared as a dialogue turn, and can more accurately specify the first utterer and the repeating utterer for each dialogue turn using the important word.

In addition, the estimation device 10 estimates the dialogue evaluation score using the trained model. In the learning device 20, the model is appropriately trained to estimate the dialogue evaluation score by machine learning in which the activity score, the activeness score, and the influence score each calculated for the training dialogue data are used as inputs and the satisfaction by the subjective evaluation of the participant with respect to the training dialogue data is used as correct answer data, and thus, it is possible to achieve the estimation of the dialogue evaluation score with high accuracy.

Then, by using the dialogue evaluation score estimated by the estimation device 10, it is possible to estimate the evaluation of the satisfaction and the achievement of the dialogue in consideration of the activeness of the speech of the participant and the promotion of the consensus building based on the content of the speech.

Further, using the evaluation estimated by the estimation device 10, it is also possible to examine the organization of the group such that the satisfaction of the participant becomes higher, and to intervene in the progress of the dialogue. In addition, when the dialogue is performed, the dialogue evaluation of the speaker is estimated using the estimation device 10 after the dialogue, so that it is possible to consciously perform the approach necessary for raising the dialogue evaluation of the participant in the next dialogue or reflect the approach in the material. Alternatively, by virtually simulating the dialogue and observing a change in the dialogue evaluation of the dialogue participant therein using the estimation device 10, it is also possible to formulate a strategy of what kind of dialogue should be performed and what kind of intervention should be performed in order to promote consensus building.

### [Regarding System Configuration of Embodiment]

Each component of the estimation device 10 and the learning device 20 is functionally conceptual, and does not have to be physically configured as illustrated in the drawings. That is, specific forms of distribution and integration of the functions of the estimation device 10 and the learning device 20 are not limited to those illustrated in the drawings, and all or a part thereof can be configured to be functionally or physically distributed or integrated in any unit according to various loads, usage conditions, and the like.

In addition, all or any part of each processing performed in the estimation device 10 and the learning device 20 may be implemented by a CPU, a graphics processing unit (GPU), and a program analyzed and executed by the CPU and the GPU. In addition, each processing performed in the estimation device 10 and the learning device 20 may be implemented as hardware by wired logic.

In addition, among the pieces of the processing described in the embodiment, all or some of the pieces of processing described as being automatically performed can be performed manually. Alternatively, all or some of the pieces of processing described as being manually performed can be automatically performed by a known method. In addition, the above-described and illustrated processing procedures, control procedures, specific names, and information including various data and parameters can be appropriately changed unless otherwise specified.

### [Program]

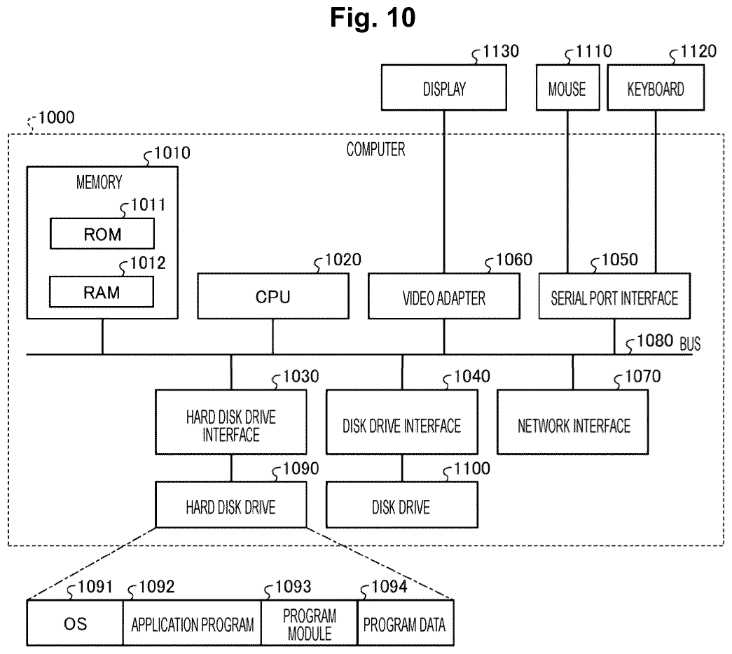

FIG. 10 is a diagram illustrating an example of a computer in which a program is executed and thus the estimation device 10 and the learning device 20 are implemented. A computer 1000 includes a memory 1010 and a CPU 1020, for example. In addition, the computer 1000 also includes a hard disk drive interface 1030, a disk drive interface 1040, a serial port interface 1050, a video adapter 1060, and a network interface 1070. These units are connected to each other via a bus 1080.

The memory 1010 includes ROM 1011 and RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected with, for example, a display 1130.

The hard disk drive 1090 stores, for example, an operating system (OS) 1091, an application program 1092, a program module 1093, and program data 1094. That is, the program that defines each piece of processing of the estimation device 10 and the learning device 20 is implemented as the program module 1093 in which codes executable by the computer 1000 are described. The program module 1093 is stored in, for example, the hard disk drive 1090. For example, the program module 1093 for executing processing similar to the functional configuration in the estimation device 10 and the learning device 20 is stored in the hard disk drive 1090. Note that the hard disk drive 1090 may be replaced with a solid state drive (SSD).

In addition, setting data used in the processing of the above-described embodiment is stored as the program data 1094, for example, in the memory 1010 or the hard disk drive 1090. Then, the CPU 1020 reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). Then, the program module 1093 and the program data 1094 may be read by the CPU 1020 from another computer via the network interface 1070.

Although the embodiment to which the invention made by the present inventor is applied has been described above, the present invention is not limited by the description and drawings constituting a part of the disclosure of the present invention according to the present embodiment. That is, other embodiments, examples, operation techniques, and the like made by those skilled in the art or the like on the basis of the present embodiment are all included in the scope of the present invention.

### REFERENCE SIGNS LIST

10 Estimation device
11, 21 Activity score calculation unit
12, 22 Activeness score calculation unit
13, 23 Dialogue turn extraction unit
14, 24 Influence score calculation unit
15 Dialogue evaluation estimation unit
20 Learning device
25 Dialogue evaluation model creation unit

1. An estimation method, comprising:
a first calculation process of receiving, as dialogue data of a plurality of persons, at least an input of a dialogue transcript, and calculating, on a basis of a linguistic feature amount of an utterance in the dialogue transcript, an activity score indicating a degree excitement of a dialogue gives to satisfaction of each participant;
a second calculation process of dividing the dialogue transcript by a time axis, and calculating, on a basis of a number of utterances and a number of utterance words of each participant in each zone, an activeness score indicating a degree activeness of a speech in a dialogue by the participant gives to satisfaction of each participant;
a third calculation process of dividing the dialogue transcript, specifying a first utterer and a repeating utterer for each divided period, and calculating an influence score indicating a degree an influence given to a process and result of consensus building by utterances of the first utterer and the repeating utterer gives to satisfaction of each participant; and
a process of estimating a dialogue evaluation score indicating evaluation of the dialogue by each participant on a basis of the activity score, the activeness score, and the influence score.

2. The estimation method according to claim 1, wherein:
in the first calculation process, input of vital data of each participant and/or individuality data indicating individuality of each participant is received as the dialogue data, and the activity score is calculated using a non-linguistic feature amount based on the vital data of each participant and/or the individuality data of each participant.

3. The estimation method according to claim 1, further comprising:
a process of extracting, as a dialogue turn, an uttered sentence in which an important word that is a word indicating an idea and a topic appears from the dialogue transcript,
wherein in the third calculation process, the first utterer and the repeating utterer are specified for each dialogue turn using the important word.

4. The estimation method according to claim 1, wherein;
in the third calculation process, the dialogue evaluation score is acquired by using a model that estimates the dialogue evaluation score using the activity score, the activeness score, and the influence score as inputs, and
the model is trained for estimation of the dialogue evaluation score by machine learning in which the activity score, the activeness score, and the influence score each calculated for training dialogue data of a plurality of persons are used as inputs, and satisfaction by subjective evaluation of a participant with respect to the training dialogue data is used as correct answer data.

5. A learning method, comprising:
a fourth calculation process of receiving, as training dialogue data of a plurality of persons, at least an input of a dialogue transcript, and calculating, on a basis of a linguistic feature amount of an utterance in the dialogue transcript, an activity score indicating a degree excitement of a dialogue gives to satisfaction of each participant;
a fifth calculation process of dividing the dialogue transcript by a time axis, and calculating, on a basis of a number of utterances and a number of utterance words of each participant in each zone, an activeness score indicating a degree activeness of a speech in a dialogue by the participant gives to satisfaction of each participant;
a sixth calculation process of dividing the dialogue transcript, specifying a first utterer and a repeating utterer for each divided period, and calculating an influence score indicating a degree an influence given to a process and result of consensus building by utterances of the first utterer and the repeating utterer gives to satisfaction of each participant; and
a creation process of creating a model for estimating a dialogue evaluation score indicating an evaluation of a dialogue by each participant by machine learning in which the activity score, the activeness score, and the influence score are used as inputs and satisfaction by subjective evaluation of a participant with respect to the training dialogue data is used as correct answer data.

6. An estimation device, comprising:
first calculation circuitry that receives, as dialogue data of a plurality of persons, at least an input of a dialogue transcript, and calculates, on a basis of a linguistic feature amount of an utterance in the dialogue transcript, an activity score indicating a degree excitement of a dialogue gives to satisfaction of each participant;
second calculation circuitry that divides the dialogue transcript by a time axis, and calculates, on a basis of a number of utterances and a number of utterance words of each participant in each zone, an activeness score indicating a degree activeness of a speech in a dialogue by the participant gives to satisfaction of each participant;
third calculation circuitry that divides the dialogue transcript, specifies a first utterer and a repeating utterer for each divided period, and calculates an influence score indicating a degree an influence given to a process and result of consensus building by utterances of the first utterer and the repeating utterer gives to satisfaction of each participant; and
estimation circuitry that estimates a dialogue evaluation score indicating evaluation of the dialogue by each participant on a basis of the activity score, the activeness score, and the influence score.

7. (canceled)

8. A non-transitory computer readable medium storing computer instruction which when executed by a processor cause the processor to perform the estimation method of claim 1.

9. A non-transitory computer readable medium storing computer instruction which when executed by a processor cause the processor to perform the estimation learning method of claim 5.
